(19) United States
(12) Patent Application Publication
(10) Pub. No.: US 2007/0252513 A1
(43) Pub. Date: Nov. 1, 2007

(54) Illumination System Comprising a Radiation Source and a Fluorescent Material

(75) Inventors: Thomas Justel, Witten (DE); Peter Schmidt, Aachen (DE); Wolfgang Schnick, Gauting (DE); Florian Manfred Stadler, Icking (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,534

(22) PCT Filed: Jun. 29, 2005
(86) PCT No.: PCT/IB05/52159

§ 371 Date: Jan. 2, 2007

(30) Foreign Application Priority Data
Jul. 5, 2004 (EP) 04103180.8

(51) Int. Cl. H01J 1/62; H01J 63/04

(52) U.S. Cl. 313/503

(57) ABSTRACT

The invention concerns an illumination system for generation of colored, especially yellow, amber or red light, comprising a radiation source and a fluorescent material comprising at least one phosphor capable of absorbing a part of light emitted by the radiation source and emitting light of wavelength different from that of the absorbed light; wherein said at least one phosphor is a yellow to red-emitting europium(II)-activated oxonitridoaluminosilicate of general formula EA_{2-z}Si₅₋ₐAlₐN₈₋ₐOₐ:Eu_{z} wherein 0<a≦2 and 0<z≦0.2; EA is at least one earth alkaline metal chosen from the group of calcium, barium and strontium.

The invention is also concerned with a red, amber or yellow-emitting a europium(II)-activated oxonitridoaluminosilicate of general formula EA_{2-z}Si₅₋ₐAlₐN₈₋ₐOₐ:Eu_{z} wherein 0<a≦2 and 0<z≦0.2; EA is at least one earth alkaline metal chosen from the group of calcium, barium and strontium.

The present invention generally relates to an illumination system comprising a radiation source and a fluorescent material comprising a phosphor. The invention also relates to a phosphor for use in such an illumination system.

More particularly, the invention relates to an illumination system comprising an electroluminescent semiconductor device as a radiation source and a fluorescent material comprising a phosphor for the generation of specific, white or colored light, including yellow, amber, and red light.

In this illumination system white or colored light is generated by luminescent down conversion and additive color mixing based on an ultraviolet or blue primary radiation.

A solid-state light-emitting diode as a source of primary radiation is especially contemplated.

Such an illumination system is especially advantageous for vehicular and signaling usage.

Vehicles include a number of different components and assemblies that have an illuminator or a signal lamp associated with them. Great interest has been shown in the use of electroluminescent semiconductor devices, such as solid-state light-emitting diodes (LEDs), as illuminators and signal indicators because they offer many potential advantages over other, conventional low-voltage light sources. Other light sources suffer from many deficiencies, viz.: conventional tungsten incandescent lamps are relatively inefficient; fluorescent and gas discharge lamps require high voltages to operate; and incandescent lamps are susceptible to damage.

Accordingly, these alternative light sources are not optimal for vehicular applications where only limited power or low voltage is available, or where high voltage is unacceptable for safety reasons, or in applications subject to significant shocks or vibrations. LEDs on the other hand are highly shock-resistant, and therefore provide significant advantages over incandescent and fluorescent bulbs, which can shatter when subjected to mechanical or thermal shocks. LEDs also possess operating lifetimes from 200,000 hours to 1,000,000 hours, as against the typical 1,000 to 2,000 hours for incandescent lamps or 5,000 to 10,000 hours for fluorescent lamps.

Current yellow, amber, or red traffic and vehicular lights, comprising electroluminescent semiconductor devices, rely on direct excitation of colored light in aluminum-gallium-indium phosphide (AlGaInP) LED chips for the generation of yellow, amber, or red light.

A drawback of AlInGaP LEDs is the quenching of the light emission with increasing temperature. Their light output drops by more than 40% if the temperature is raised from room temperature to 100° C. At the same time the spectrum shifts, for example from 617 nm to 623 nm, which reduces the luminous efficacy further. Therefore, there is a strong demand on the part of the automotive industry for yellow to red LEDs with a much smaller dependence of the light output and emission spectrum on temperature.

One presently discussed solution for generation of yellow, amber, or red light is the application of white LEDs and an appropriate color filter, since the AlInGaN chips used in white LEDs show much less thermal quenching. In addition, the spectral shift of white LEDs with temperature is less severe due to the use of the YAG:Ce phosphor. However, the major drawback of this concept is the low luminous efficacy? due to the fact that the present white LEDs emit only a few percents of orange to red light, and most of the white LED spectrum is cut off.

Another approach is known, e.g. from U.S. Pat. No. 6,649,946, wherein a light source for generating yellow to red light by using a yellow-to-red-emitting phosphor is disclosed. Said phosphor has a host lattice of the nitridosilicate type MₓSi_{y}N_{z}:Eu, wherein M is at least one alkaline earth metal chosen from the group Ca, Sr, Ba, Zn, and wherein z=⅔x+ 4/3y. The phosphor can be used to create a highly stable red or orange or yellow-emitting LED which may be based on a primary light source (preferably an InGaN chip) with a peak emission around 380 to 480 nm, whose light is fully converted by a nitride phosphor of the inventive type rare-earth activated silicon nitrides doped with Eu. These LEDs show a higher luminous efficacy and a better stability than well-known commercial LEDs with direct excitation of yellow to red colors.

Yet, a recent evaluation of the chromaticity requirements for traffic signs has indicated that the red color range of vehicular and traffic signs should include a longer-wavelength cut-off to ensure detection of the signal by color vision deficient drivers.

Therefore, there is a need to provide an illumination system comprising phosphors that are excitable by a radiation source of the near UV-to-blue range and emit in the visible amber to deep-red range.

Thus the present invention provides an illumination system, comprising a radiation source and a fluorescent material comprising at least one phosphor capable of absorbing part of the light emitted by the radiation source and emitting light of a wavelength different from that of the absorbed light; wherein said at least one phosphor is a europium(II)-activated oxonitridoaluminosilicate of the general formula

EA_{2-z}Si₅₋ₐAlₐN₈₋ₐOₐ:Eu_{z},wherein 0<a≦2 and 0<z≦0.2; EA being at least one alkaline earth metal chosen from the group of calcium, barium, and strontium.

An illumination system according to the present invention can provide a composite colored output light, especially yellow, amber, or red light, with a high temperature resistance, color point stability, and a high luminous efficacy at the same time.

In particular, the composite output light has a greater amount of emission in the deep red color range than the conventional lamp and enlarges the range of colors that can be reproduced. This characteristic makes the device ideal for applications, such as yellow, amber, and red traffic lighting, stair/exit ramp lighting, decorative lighting, and signal lighting for vehicles.

An illumination system according to the present invention can also provide a composite white output light that is well balanced with respect to color. In particular, the composite white output light has a greater amount of emission in the red color range than the conventional lamp. This characteristic makes the device ideal for applications in which a true color rendering is required.

Such applications of the invention include inter alia traffic lighting, street lighting, security lighting and lighting of automated factories.

Especially contemplated as the radiation source is a solid-state light-emitting diode.

According to a first aspect of the invention, an illumination system comprises a blue-light emitting diode having a peak emission wavelength in the range of 420 to 495 nm as a radiation source and a fluorescent material comprising at least one phosphor, which is a europium(II)-activated oxonitridoaluminosilicate of the general formula

EA_{2-z}Si₅₋ₐAlₐN₈₋ₐOₐ:Eu_{z}, wherein 0<a≦2 and 0 <z≦0.2; EA being at least one alkaline earth metal chosen from the group of calcium, barium, and strontium.

Such an illumination system will provide white or colored light, especially yellow, amber, or red light, in operation. The blue light emitted by the LED excites the phosphor, causing it to emit yellow, amber, or red light. The blue light emitted by the LED is transmitted through the phosphor and is mixed with the yellow light emitted by the phosphor. The viewer perceives the mixture of blue and yellow light as white or colored light, depending on the amount of phosphor present in the fluorescent material.

One embodiment of the invention provides a white or colored, especially yellow, amber or red light illumination system comprising a blue-light emitting diode having a peak emission wavelength in the range of 420 to 495 nm as a radiation source and a fluorescent material comprising a europium(II)-activated oxonitridoaluminosilicate of the general formula EA_{2-z}Si₅₋ₐAlₐN₈₋ₐOₐ:Eu_{z}, wherein 0<a≦2 and 0<z≦0.2; EA being at least one alkaline earth metal chosen from the group of calcium, barium, and strontium, and at least one second phosphor.

When the fluorescent material comprises a phosphor blend of a phosphor of the europium(II)-activated oxonitridoaluminosilicate type and at least one second phosphor, the color rendering of the white or colored illumination system according to the invention may be further improved.

In particular, the fluorescent material may be a phosphor blend comprising europium(II)-activated oxonitridoaluminosilicate of the general formula

EA_{2-z}Si₅₋ₐAlₐN₈₋ₐOₐ:Eu_{z}, wherein 0<a≦2 and 0<z≦0.2; EA being at least one alkaline earth metal chosen from the group of calcium, barium, and strontium, and a red phosphor. Such a red phosphor may be selected from the group of Ca_{1-x-y}SrₓS:Eu_{y}, wherein 0≦x≦1 and 0<y≦0.2; and (Sr_{1-x-y}BaₓCa_{y})₂Si₅N₈:Eu_{z}, wherein 0≦x≦1, 0≦y≦1 and 0<z≦0.2.

The fluorescent material may alternatively be a phosphor blend comprising a europium(II)-activated oxonitridoaluminosilicate of the general formula

EA_{2-z}Si₅₋ₐAlₐN₈₋ₐOₐ:Eu_{z}, wherein 0<a≦2 and 0<z≦0.2; EA being at least one alkaline earth metal chosen from the group of calcium, barium, and strontium, and a yellow-to-green phosphor. Such a yellow to green phosphor may be selected from the group comprising (CaₓSr_{1-x-y})₂SiO₄:Eu_{y}, wherein 0≦x≦ and 0<y≦0.2, (SrₓBa_{1-x-y})₂SiO₄:Eu_{y}, wherein 0≦x≦1 and 0<y≦0.2, (Sr_{1-x-y}Baₓ)Ga₂S₄:Eu_{y}, wherein 0≦x≦1 and

0<y≦0.2, (Y_{1-x-y-z}GdₓLu_{z})₃(Al₁₋ₐGaₐ)₅O₁₂:Ce_{y}, wherein 0≦x≦1 and 0<y≦0.2,

0≦z≦1, 0≦a≦0.5, ZnS:Cu, CaS:Ce,Cl, and SrSi₂N₂O₂:Eu.

The fluorescent material may alternatively be a phosphor blend comprising a europium(II)-activated oxonitridoaluminosilicate of the general formula

EA_{2-z}Si₅₋ₐAlₐN₈₋ₐOₐ:Eu_{z}, wherein 0<a≦2 and 0<z≦0.2; EA being at least one alkaline earth metal chosen from the group of calcium, barium, and strontium, and a blue phosphor. Said blue phosphor may be selected from the group comprising BaMgAl₁ₒ0₁₇:Eu, Ba₅SiO₄(Cl,Br)₆:Eu, CaLa₂S_{4:}Ce, (Sr,Ba,Ca)₅(PO₄)₃Cl:Eu, and LaSi₃N₅:Ce.

The emission spectrum of such a fluorescent material comprising additional phosphors has wavelengths suitable for obtaining a high-quality colored light with good color rendering at the required color temperature in combination with the blue light of the LED and the yellow to red light of the europium(II)-activated oxonitridoaluminosilicate type phosphor according to the invention.

According to another aspect of the invention, a white or colored, especially yellow, amber, or red-light illumination system is provided, wherein the radiation source is selected from the light-emitting diodes having an emission with a peak emission wavelength in the UV-range of 200 to 420 nm and the fluorescent material comprises at least one phosphor, which is a europium(II)-activated oxonitridoaluminosilicate of the general formula EA_{2-z}Si₅₋ₐAlₐN₈₋ₐOₐ:Eu_{z}, wherein 0<a≦2 and 0<z≦0.2; EA being at least one alkaline earth metal chosen from the group of calcium, barium, and strontium.

One embodiment of the invention provides a white-light illumination system comprising a blue-light emitting diode having a peak emission wavelength in the UV-range of 200 to 420 nm as a radiation source and a fluorescent material comprising a europium(II)-activated oxonitridoaluminosilicate of the general formula

EA_{2-z}Si₅₋ₐAlₐN₈₋ₐOₐ:Eu_{z}, wherein 0<a≦2 and 0<z≦0.2; EA being at least one alkaline earth metal chosen from the group of calcium, barium, and strontium, and at least one second phosphor.

In particular, the fluorescent material may be a phosphor blend comprising europium(II)-activated oxonitridoaluminosilicate of the general formula

EA_{2-z}Si₅₋ₐAlₐN₈₋ₐOₐ:Eu_{z}, wherein 0<a≦2 and 0<z≦0.2; EA being at least one alkaline earth metal chosen from the group of calcium, barium, and strontium, and a red phosphor. Such a red phosphor may be selected from the group of Ca_{1-x-y}SrₓS:Eu_{y}, wherein 0≦x≦1 and 0<y≦0.2; and (Sr_{1-x-y}BaₓCa_{y})₂Si₅N₈:Eu_{z}, wherein 0≦x≦1, 0≦y≦1 and 0<z≦0.2.

The fluorescent material may alternatively be a phosphor blend comprising a europium(II)-activated oxonitridoaluminosilicate of the general formula

EA_{2-z}Si₅₋ₐAlₐN₈₋ₐOₐ:Eu_{z}, wherein 0<a≦2 and 0<z≦0.2; EA being at least one alkaline earth metal chosen from the group of calcium, barium, and strontium, and a yellow-to-green phosphor. Such a yellow-to-green phosphor may be selected from the group comprising (CaₓSr_{1-x-y})₂SiO₄:Eu_{y}, wherein 0≦x≦ and 0<y≦0.2, (SrₓBa_{1-x-y})₂SiO₄:Eu_{y}, wherein 0≦x≦1 and 0<y≦0.2, (Sr_{1-x-y}Baₓ)Ga₂S₄: Eu_{y}, wherein 0≦x≦1 and

0<y≦0.2, (Y_{1-x-y-z}GdₓLu_{z})₃(Al₁₋ₐGaₐ)₅O₁₂:Ce_{y}, wherein 0≦x≦1 and 0<y≦0.2,

0≦z≦1, 0≦a≦0.5, ZnS:Cu, CaS:Ce,Cl, and SrSi₂N₂O₂:Eu.

The fluorescent material may alternatively be a phosphor blend comprising a europium(II)-activated oxonitridoaluminosilicate of the general formula

EA_{2-z}Si₅₋ₐAlₐN₈₋ₐOₐ:Eu_{z}, wherein 0<a≦2 and 0<z≦0.2; EA being at least one alkaline earth metal chosen from the group of calcium, barium, and strontium, and a blue phosphor. Such a blue phosphor may be selected from the group comprising BaMgAl₁ₒ0₁₇:Eu, Ba₅SiO₄(Cl,Br)₆:Eu, CaLa₂S₄:Ce, (Sr,Ba,Ca)₅(PO₄)₃Cl:Eu, and LaSi₃N₅:Ce.

The emission spectrum of such a fluorescent material comprising additional phosphors has wavelengths suitable for obtaining a high-quality colored light with good color rendering at the required color temperature in conjunction with the blue light of the LED and the yellow to red light of the europium(II)-activated oxonitridoaluminosilicate type phosphor according to the invention.

Another aspect of the present invention provides a phosphor capable of absorbing a part of the light emitted by the radiation source and emitting light of a wavelength different from that of the absorbed light; wherein said phosphor is a europium(II)-activated oxonitridoaluminosilicate of the general formula EA_{2-z}Si₅₋ₐAlₐN₈₋ₐOₐ:Eu_{z}, wherein 0<a≦2 and 0<z≦0.2; EA being at least one alkaline earth metal chosen from the group of calcium, barium, and strontium.

By varying the chemical composition of the phosphor, the phosphor color can be shifted from a reddish orange to a deep red. The emission spectra extend in relatively inaccessible regions of the spectrum, including the deep red and near infrared.

The fluorescent material is excitable by UV-A emission lines which have wavelengths such as from 200 nm to 420 nm, but is excited with higher efficiency by blue light emitted by a blue light emitting diode having a wavelength around 400 to 495 nm. Thus the fluorescent material has ideal characteristics for a conversion of blue light of a nitride semiconductor light-emitting component into white or colored light.

These phosphors are broad-band emitters wherein the visible emission is so broad that there is no 80-nm wavelength range where the visible emission is predominantly located. The total conversion efficiency may be up to 90%.

Additional important characteristics of the europium(II)-activated oxonitridoaluminosilicate type phosphors include 1) resistance to thermal quenching of luminescence at typical device operating temperatures (e.g. 80° C.); 2) lack of interfering reactivity with the encapsulating resins used in the device manufacture; 3) suitable absorptive profiles to minimize dead absorption within the visible spectrum; 4) a temporally stable lumen output over the operating lifetime of the device, and; 5) compositionally controlled tuning of the phosphors' excitation and emission properties.

These europium(II)-activated oxonitridoaluminosilicate type phosphors may also include ytterbium, samarium, and other cations including mixtures of cations as co-activators.

These phosphors may have a coating selected from the group of fluorides and orthophosphates of the elements aluminum, scandium, yttrium, lanthanum, gadolinium, and lutetium, the oxides of aluminum, yttrium, and lanthanum, and the nitride of aluminum.

The present invention focuses on a europium(II)-activated oxonitridoaluminosilicate as a phosphor in any configuration of an illumination system containing a radiation source, including, but not limited to, discharge lamps, fluorescent lamps, LEDs, LDs, and X-ray tubes. As used herein, the term “radiation” encompasses radiation in the UV, IR, and visible regions of the electromagnetic spectrum.

While the use of the present phosphor is contemplated for a wide variety of illumination purposes, the present invention is described with particular reference to and finds particular application in phosphor-converted light-emitting diodes comprising especially UV- and blue-light-emitting diodes as radiation sources.

The phosphor conforms to the general formula EA_{2-z}Si₅₋ₐAlₐN₈₋ₐOₐ:Eu_{z} with 0<a≦2 and 0<z≦0.2; EA is at least one alkaline earth metal chosen from the group of calcium, barium, and strontium.

This class of phosphor materials is based on europium(II)-activated luminescence of an oxygen- and aluminum-substituted nitridosilicate. The phosphor of the general formula EA_{2-z}Si₅₋ₐAlₐN₈₋ₐOₐ:Eu_{z} wherein 0<a≦2 and 0<z≦0.2; EA being at least one alkaline earth metal chosen from the group of calcium, barium, and strontium, comprises a host lattice whose main components are silicon and nitrogen. The host lattice also comprises oxygen and aluminum. The host lattice is supposed to have a structure consisting of (N—Si—N—) and (O—Si/Al—N)-units in a three-dimensional network, wherein silicon is tetrahedrically surrounded by nitrogen and oxygen.

A series of compositions of the general formula EA_{2-z}Si₅₋ₐAlₐN₈₋ₐOₐ:Eu_{z} can be manufactured, which form a complete solid solution for the range 0<a≦2 and

0<z≦0.2. and crystallize in the orthorhombic crystal system

Table 1 discloses crystallographic data, CIE 1931 color coordinates, and emission wavelengths of compositions according to the formula (Sr_{1-x-y}Baₓ)₂Si₅₋ₐAlₐN₈₋ₐOₐ:Eu_{y}. in comparison with prior art compositions (in italics).

| Composition | a [Å] | b [Å] | c [Å] | λₘₐₓ [nm] | x | y |
|---|---|---|---|---|---|---|
| Sr₂Si₃Al₂N₆O₂: Eu | 9.551 | 6.739 | 5.801 | 640 | 0.636 | 0.363 |
| Sr₂Si₅N₈: Eu | 9.341 | 6.821 | 5.711 | 620 | 0.616 | 0.383 |
| Ba₂Si₅N₈: Eu | 9.391 | 6.959 | 5.783 | 580 | 0.516 | 0.482 |

The incorporation of oxygen and aluminum in the host lattice increases the proportion of covalent bonding and ligand-field splitting. This leads to a shift of excitation and emission bands to longer wavelengths compared with the basic nitridosilicate lattices.

Within the three-dimensional network, metal ions such as alkaline earth metals as well as europium(II), and possibly a co-activator, are incorporated. The alkaline earth metals are preferably selected from calcium, strontium, and barium. The host lattice for these materials may be six-element (two cation) oxonitridoaluminosilicate such as europium(II)-activated strontium oxonitridoaluminosilicate Sr₂Si₃Al₂N₆O₂:Eu, for example, or may comprise more than six elements such as europium(II)-activated strontium-barium oxonitridoaluminosilicate (Sr,Ba)₂Si₃Al₂N₆O₂:Eu, for example.

The proportion z of europium(II) is preferably in a range of 0.05<z<0.2.

If the proportion z of Eu(II) is lower, luminance decreases because the number of excited emission centers of photoluminescence due to europium(II)-cations decreases and, if z is greater than 0.2, density quenching occurs. Density quenching is the decrease in emission intensity which occurs when the concentration of an activation agent added to increase the luminance of the fluorescent material is increased beyond an optimum level.

These europium(II)-activated oxonitridoaluminosilicate phosphors are responsive to portions of the electromagnetic spectrum more energetic than the visible portion of the spectrum.

In particular, the phosphors according to the invention are especially excitable by UVemission lines which have wavelengths from 200 to 420 nm, but are excited with higher efficiency by LED light emitted by a blue light emitting component having a wavelength from 400 to 495 nm. Thus the fluorescent material has ideal characteristics for converting blue light of nitride semiconductor light-emitting component into white or colored yellow, amber or red light.

These red to yellow-red emitting phosphors are prepared in the following technique: To prepare the mixed oxides, high-purity nitrates, carbonates, oxalates, and acetates of the alkaline earth metals and europium(III) are dissolved by stirring in 25-30 ml deionized water. The solutions are stirred with heating on a hot-plate until the water has evaporated, resulting in a white or yellow paste, depending on the composition.

The solids are dried overnight (12 hours) at 120° C. The resulting solid is finely ground and placed in a high-purity alumina crucible. The crucibles are loaded into a charcoal-containing basin and then into a tube furnace and purged with flowing nitrogen/hydrogen for several hours. The furnace parameters are 10° C./min to 1600° C., followed by a 4-hour dwell at 1300° C., after which the furnace is turned off and allowed to cool down to room temperature.

These metal oxides are mixed with silicon nitride Si₃N₄ and aluminum nitride AlN in predetermined ratios.

The powder mixture is placed in a high-purity alumina crucible. The crucibles are loaded into a charcoal-containing basin and then into a tube furnace and purged with flowing nitrogen/hydrogen for several hours. The furnace parameters are 10° C./min to 1600° C., followed by a 4-hour dwell at 1600° C., after which the furnace is slowly cooled down to room temperature.

The samples are once again finely ground before a second annealing step at 1600° C. is performed.

Lumen output may be improved through an additional third anneal at slightly lower temperatures in flowing argon.

The phosphors according to the invention are resistant to heat, light, and moisture because of their oxonitridoaluminosilicate structure.

Each phosphor of the europium(II)-activated oxonitridoaluminosilicate type emits a yellow, amber, or deep red fluorescence when excited by radiation of the UVA or blue range of the electromagnetic spectrum.

When excited with radiation of 495 nm wavelength, this europium(II) activated oxonitridoaluminosilicate phosphor is found to give a broad-band emission with a peak wavelength at 640 nm and a tail emission of up to 750 nm.

These europium-activated oxonitridoaluminosilicate phosphors can be excited efficiently with radiation of a wavelength between 370 nm and 490 nm.

Preferably, the europium(II)-activated oxonitridoaluminosilicate type phosphors according to the invention may be coated with a thin, uniform protective layer of one or more compounds selected from the group formed by the fluorides and orthophosphates of the elements aluminum, scandium, yttrium, lanthanum, gadolinium, and lutetium, the oxides of aluminum, yttrium, and lanthanum, and the nitride of aluminum.

The protective layer thickness customarily ranges from 0.001 to 0.2 μm and is thus so thin that it can be penetrated by the radiation of the radiation source without substantial loss of energy. The coatings of these materials on the phosphor particles may be applied, for example, by deposition from the gas phase in a wet coating process.

The invention also relates to an illumination system comprising a radiation source and a fluorescent material comprising at least one europium-activated oxonitridoaluminosilicate of the general formula EA_{2-z}Si₅₋ₐAlₐN₈₋ₐOₐ:Eu_{z}, wherein 0<a≦2 and 0<z≦0.2; EA being at least one alkaline earth metal chosen from the group of calcium, barium, and strontium.

Radiation sources include semiconductor optical radiation emitters and other devices that emit optical radiation in response to electrical excitation. Semiconductor optical radiation emitters include light-emitting diode LED chips, light-emmitting polymers (LEPs), organic light-emitting devices (OLEDs), polymer light-emitting devices (PLEDs), etc.

Moreover, light-emitting components such as those found in discharge lamps and fluorescent lamps, such as mercury low and high-pressure discharge lamps, sulfur discharge lamps, and discharge lamps based an molecular radiators are also contemplated for use as radiation sources with the present inventive phosphor compositions.

In a preferred embodiment of the invention, the radiation source is a solid state light-emitting diode.

Any configuration of an illumination system which includes a solid state LED and a europium-activated oxonitridoaluminosilicate phosphor composition is contemplated in the present invention, preferably with the addition of other well-known phosphors which may be combined to achieve a specific colored yellow, amber, red or white light when irradiated by a LED emitting primary UV or blue radiation as specified above.

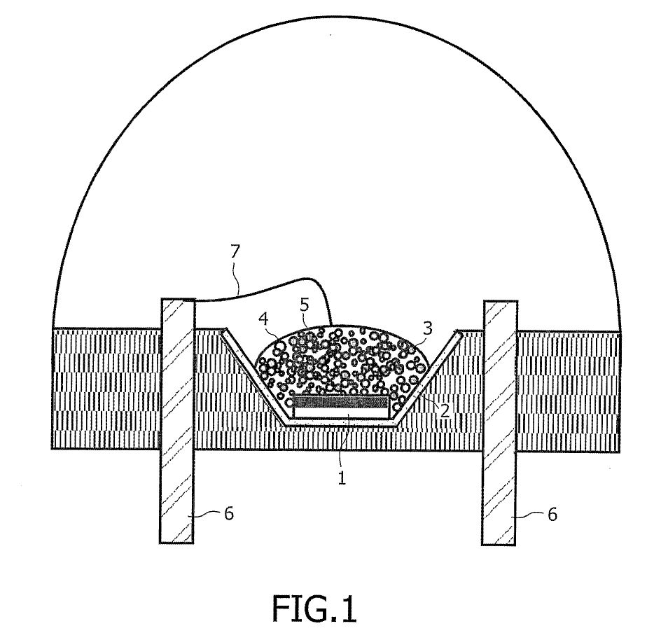

A detailed construction of one embodiment of such an illumination system comprising a radiation source and a fluorescent material shown in FIG. 1 will now be described.

FIG. 1 shows a schematic view of a chip type light-emitting diode with a coating comprising the fluorescent material. The device comprises a chip type light-emitting diode (LED) 1 as a radiation source. The light-emitting diode dice is positioned in a reflector cup lead frame 2. The dice 1 is connected via a bond wire 7 to a first terminal 6, and directly to a second electric terminal 6. The recess of the reflector cup is filled with a coating material which contains a fluorescent material 4, 5 according to the invention to form a coating layer which is embedded in the reflector cup. The phosphors are applied either separately or in a mixture.

The coating material typically comprises a polymer 3 for encapsulating the phosphor or phosphor blend. In this embodiment, the phosphor or phosphor blend should exhibit high-stability properties against the encapsulant. Preferably, the polymer is optically clear to prevent significant light scattering. A variety of polymers are known in the LED industry for making LED lamps.

In one embodiment, the polymer is selected from the group consisting of epoxy and silicone resins Adding the phosphor mixture to a liquid that is a polymer precursor can result in encapsulation. For example, the phosphor mixture may be a granular powder. Introducing phosphor particles into polymer precursor liquid results in the formation of a slurry (i.e. a suspension of particles). Upon polymerization, the phosphor mixture is fixed rigidly in place by the encapsulation. In one embodiment, both the fluorescent material and the LED dice are encapsulated in the polymer.

The transparent coating material may advantageously comprise light-diffusing particles, so-called diffusers. Examples of such diffusers are mineral fillers, in particular CaF₂, TiO₂, SiO₂, CaCO₃, and BaSO₄, or else organic pigments. These materials can be added in a simple manner to the above-mentioned resins.

In operation, electrical power is supplied to the dice to activate the dice. When activated, the dice emits the primary light, e.g. blue light. A portion of the emitted primary light is completely or partly absorbed by the fluorescent material in the coating layer. The fluorescent material then emits secondary light, i.e., the converted light having a longer peak wavelength, primarily yellow in a sufficiently broad band (specifically with a significant proportion of red) in response to absorption of the primary light. The remaining unabsorbed portion of the emitted primary light is transmitted through the fluorescent layer, along with the secondary light. The encapsulation directs the unabsorbed primary light and the secondary light in a general direction as output light. Thus, the output light is a composite light that is composed of the primary light emitted from the dice and the secondary light emitted from the fluorescent layer.

The color temperature or color point of the output light of an illumination system according to the invention will vary in dependence on the spectral distributions and intensities of the secondary light in comparison with the primary light.

Firstly, the color temperature or color point of the primary light can be varied by a suitable choice of the light-emitting diode

Secondly, the color temperature or color point of the secondary light can be varied by a suitable choice of the phosphor in the luminescent material, its particle size and its concentration. Furthermore, these arrangements also advantageously afford the possibility of using phosphor blends in the luminescent material, as a result of which, advantageously, the desired hue can be set even more accurately.

According to first aspect of the invention, an illumination system that emits output light having a spectral distribution such that it appears to be yellow, amber, or red light is contemplated.

Fluorescent material comprising europium-activated oxonitridoaluminosilicate as its phosphor is particularly well suited as a yellow, amber, or red component for stimulation by a primary UVA or blue radiation source such as, for example, an UVA-emitting LED or blue-emitting LED.

It is possible thereby to implement an illumination system emitting in the yellow to red regions of the electromagnetic spectrum.

In a first embodiment, a yellow-light emitting illumination system according to the invention can advantageously be produced by choosing the luminescent material such that a blue radiation emitted by the blue-light emitting diode is converted into complementary wavelength ranges, to form dichromatic colored, especially yellow, amber, or red light.

In this case, colored light is produced by means of the luminescent materials, which comprise a europium-activated oxonitridoaluminosilicate phosphor.

Particularly good results are achieved with a blue LED whose emission maximum lies at 400 to 495 nm. An optimum has been found to lie at 445 to 465 nm, taking particular account of the excitation spectrum of the oxonitridoaluminosilicate phosphor.

The color output of the LED-phosphor system is very sensitive to the thickness of the phosphor layer, if the phosphor layer is thick and comprises an excess of a yellow europium-activated oxonitridoaluminosilicate phosphor, then a smaller proportion of the blue LED light will penetrate through the thick phosphor layer. The combined LED-phosphor system will then appear yellow to red, because it is dominated by the yellow to red secondary light of the phosphor. Therefore, the thickness of the phosphor layer is a critical variable affecting the color output of the system.

The hue (color point in the CIE chromaticity diagram) of the yellow light thus produced can be varied in this case by a suitable choice of the phosphor mixture and concentration.

The color points of the illumination systems according to this embodiment are in the yellow to red spectral range in the chromaticity diagram of the Commission Internationale de l'Eclairage (“CIE”).

A yellow, amber or red-light emitting illumination system according to the invention can be realized particularly preferably by admixing an excess of the inorganic luminescent material Sr₂Si₃Al₂N₆O₂:Eu with a silicone resin used to produce the luminescence conversion encapsulation or layer. Part of a blue radiation emitted by a 462-nm InGaN light-emitting diode is shifted by the inorganic luminescent material Sr₂Si₃Al₂N₆O₂:Eu into the yellow, amber, or red spectral region and, consequently, into a wavelength range which is complementarily colored with respect to the color blue. A human observer will perceive the combination of blue primary light and the excess secondary light of the phosphor as yellow, amber, or red light.

Yellow to red LEDs with a color point on the line connecting x=0.516, y=0.482 and x=0.636, y=0.363 can be realized by this single-phosphor dichromatic concept if the appropriate member of the composition according to the formula:

EA_{2-z}Si₅₋ₐAlₐN₈₋ₐOₐ:Eu_{z}, where in 0<a≦2 and 0<z≦0.2; EA being chosen from strontium and barium

In a second embodiment, colored-light emitting illumination system according to the invention can advantageously be produced by choosing the luminescent material such that a blue radiation emitted by the blue-light emitting diode is converted into complementary wavelength ranges to form polychromatic yellow, amber, or red light. In this case, colored light is produced by means of the luminescent materials, which comprise a blend of phosphors including europium-activated oxonitridoaluminosilicate phosphor and a second phosphor.

Useful second phosphors and their optical properties are summarized in the following Table 2:

| Composition | λₘₐₓ [nm] | Color point x, y |
|---|---|---|
| (Ba₁₋ₓSrₓ)₂SiO₄: Eu | 523 | 0.272, 0.640 |
| SrGa₂S₄: Eu | 535 | 0.270, 0.686 |
| SrSi₂N₂O₂: Eu | 541 | 0.356, 0.606 |
| SrS: Eu | 610 | 0.627, 0.372 |
| (Sr_{1-x-y}CaₓBa_{y})₂Si₅N₈: Eu | 615 | 0.615, 0.384 |
| CaS: Eu | 655 | 0.700, 0.303 |

The luminescent materials may be a blend of two phosphors, a yellow to red europium activated oxonitridoaluminosilicate phosphor and a red phosphor selected from the group Ca_{1-x-y}SrₓS:Eu_{y}, wherein 0≦x≦1 and 0<y≦0.2; and

(Sr_{1-x-y}BaₓCa_{y})₂Si₅N₈:Eu_{z}, wherein 0≦x≦1, 0≦y≦1 and 0<z≦0.2.

A orange to red-light emitting illumination system according to the invention can be realized particularly preferably by admixing an excess of the inorganic luminescent blend of Ba₂Si₅N₈:Eu and Sr₂Si₃Al₂N₆O₂:Eu with a silicone resin used to produce the luminescence conversion encapsulation or layer. Part of a blue radiation emitted by a 462-nm InGaN light-emitting diode is shifted by the inorganic luminescent material comprising Ba₂Si₅N₈:Eu and Sr₂Si₃Al₂N₆O₂:Eu into the orange to red spectral region and, consequently, into a wavelength range which is complementarily colored with respect to the color blue. A human observer will perceive the combination of blue primary light and the excess secondary light of the phosphors as orange to red light.

Orange to red emitting LEDs with a color point on the line connecting x=0.516, y=0.482 and x=0.636, y=0.363 can be made by the use of a luminescent material which comprises a blend of Ba₂Si₅N₈:Eu and Sr₂Si₃Al₂N₆O₂:Eu.

The luminescent materials may be a blend of two phosphors, a yellow to red europium-activated oxonitridoaluminosilicate phosphor and a yellow to green phosphor selected from the group comprising (CaₓSr_{1-x-y})₂SiO₄:Eu_{y}, wherein 0≦x≦ and 0<y≦0.2, (SrₓBa_{1-x-y})₂SiO₄:Eu_{y}, wherein 0≦x≦1 and 0<y≦0.2, (Sr_{1-x-y}Baₓ)Ga₂S₄:Eu_{y}, wherein 0≦x≦1 and 0<y≦0.2, (Y_{1-x-y-z}GdₓLu_{z})₃(Al₁₋ₐGaₐ)₅O₁₂:Ce_{y}, wherein 0≦x≦1 and

0<y≦0.2, 0≦z≦1, 0≦a≦0.5, ZnS:Cu, CaS:Ce,Cl, and SrSi₂N₂O₂:Eu.

The luminescent materials may be a blend of two phosphors, a yellow to red europium-activated oxonitridoaluminosilicate phosphor and a blue phosphor selected from the group comprising BaMgAl₁ₒ0₁₇:Eu, Ba₅SiO₄(Cl,Br)₆:Eu, CaLa₂S₄:Ce, (Sr,Ba,Ca)₅(PO₄)₃Cl:Eu, and LaSi₃N₅:Ce.

The luminescent materials may be a blend of three phosphors, e.g. a yellow to red europium-activated oxonitridoaluminosilicate phosphor, a red phosphor selected from the group Ca_{1-x-y}SrₓS:Eu_{y}, wherein 0≦x≦1 and 0<y≦0.2; and

(Sr_{1-x-y}BaₓCa_{y})₂Si₅N₈:Eu_{z}, wherein 0≦x≦1, 0≦y≦1 and 0<z≦0.2, and a yellow to green phosphor selected from the group comprising (CaₓSr_{1-x-y})₂SiO₄:Eu_{y}, wherein

0≦x≦ and 0<y≦0.2, (SrₓBa_{1-x-y})₂SiO₄:Eu_{y}, wherein 0≦x≦1 and 0<y≦0.2,

(Sr_{1-x-y}Baₓ)Ga₂S₄:Eu_{y}, wherein 0≦x≦1 and 0<y≦0.2,

(Y_{1-x-y-z}GdₓLu_{z})₃(Al₁₋ₐGaₐ)₅O₁₂:Ce_{y} wherein 0≦x≦1 and 0<y≦0.2, 0≦z≦1,

0≦a≦0.5, ZnS:Cu, CaS:Ce,Cl, and SrSi₂N₂O₂:Eu.

In the example given above, the red-light emitting illumination system according to the invention can particularly preferably be realized by admixing the inorganic luminescent material comprising a mixture of three phosphors with a silicone resin used to produce the luminescence conversion encapsulation or layer. A first phosphor (1) is the yellowish-emitting Ba₂Si₅N₈:Eu, the second phosphor (2) is the red-emitting Sr₂Si₅N₈:Eu, and the third (3) is a deep red-emitting phosphor of the oxonitridoaluminosilicate type Sr₂Si₃Al₂N₆O₂:Eu.

Part of a blue radiation emitted by a 462-nm InGaN light-emitting diode is shifted by the inorganic luminescent material Ba₂Si₅N₈:Eu, into the yellow spectral region and, consequently, into a wavelength range which is complementarily colored with respect to the color blue. Another part of the blue radiation emitted by a 462-nm InGaN light-emitting diode is shifted by the inorganic luminescent material Sr₂Si₅N₈:Eu into the red spectral region. Still another part of the blue radiation emitted by a 462 nm InGaN light-emitting diode is shifted by the inorganic luminescent material Sr₂Si₃Al₂N₆O₂:Eu into the deep red spectral region. A human observer will perceive the combination of blue primary light and the polychromatic secondary light of the phosphor blend as red light.

The hue (color point in the CIE chromaticity diagram) of the red light thus produced can be varied in this case by a suitable choice of the phosphors as regards their mixture and concentrations.

In a second aspect of the invention, a yellow, amber, or red-light emitting illumination system according to the invention can advantageously be produced by choosing the luminescent material such that a UV radiation emitted by the UV-emitting diode is converted entirely into monochromatic yellow to red light. In this case, the yellow to red light is produced by means of the luminescent materials.

In a first embodiment, a yellow-light emitting illumination system according to the invention can advantageously be produced by choosing the luminescent material such that a blue radiation emitted by the UV light emitting diode is converted into complementary wavelength ranges to form dichromatic colored, especially yellow, amber, or red light.

In this case, colored light is produced by means of the luminescent materials, which comprise a europium-activated oxonitridoaluminosilicate phosphor.

Particularly good results are achieved with a UV LED whose emission maximum lies at near UV from 370 to 430 nm.

The color output of the illumination system comprising an UV LED as its radiation source is not very sensitive to the thickness of the phosphor layer. Therefore, the thickness of the phosphor layer is not a critical variable affecting the color output of the system and may be reduced.

The hue (color point in the CIE chromaticity diagram) of the yellow light thus produced can be varied in this case by a suitable choice of the phosphor mixture and concentration.

The color points of the illumination systems according to this embodiment are in the yellow to red spectral range in the chromaticity diagram of the Commission Internationale de l'Eclairage (“CIE”).

A yellow, amber or red-light emitting illumination system according to the invention can particularly preferably be realized by admixing an excess of the inorganic luminescent material Sr₂Si₃Al₂N₆O₂:Eu with a silicone resin used to produce the luminescence conversion encapsulation or layer. Part of a UV radiation emitted by a UV-light emitting diode is shifted by the inorganic luminescent material Sr₂Si₃Al₂N₆O₂:Eu into the yellow, amber, or red spectral region and, consequently, into a wavelength range which is complementarily colored with respect to the color blue. A human observer will perceive the combination of blue primary light and the excess secondary light of the phosphor as yellow, amber, or red light.

Yellow to red LEDs with a color point on the line connecting x=0.516, y=0.482 and x=0.636, y=0.363 can be realized by this single-phosphor dichromatic concept if the appropriate member of the composition according to the formula:

(Sr_{1-x-y}Baₓ)₂Si₅₋ₐAlₐN₈₋ₐOₐ:Eu_{y} is chosen.

In a second embodiment, a colored-light emitting illumination system according to the invention can advantageously be produced by choosing the luminescent material such that UV-radiation emitted by the UV-emitting diode is converted into wavelength ranges so as to form polychromatic yellow, amber, or red light. In this case, colored light is produced by means of the luminescent materials, which comprise a blend of phosphors including europium-activated oxonitridoaluminosilicate phosphor and a second phosphor.

Useful second phosphors and their optical properties are summarized in the following Table 2:

| Composition | λₘₐₓ [nm] | Color point x, y |
|---|---|---|
| (Ba₁₋ₓSrₓ)₂SiO₄: Eu | 523 | 0.272, 0.640 |
| SrGa₂S₄: Eu | 535 | 0.270, 0.686 |
| SrSi₂N₂O₂: Eu | 541 | 0.356, 0.606 |
| SrS: Eu | 610 | 0.627, 0.372 |
| (Sr_{1-x-y}CaₓBa_{y})₂Si₅N₈: Eu | 615 | 0.615, 0.384 |
| CaS: Eu | 655 | 0.700, 0.303 |

The luminescent materials may be a blend of two phosphors, a yellow to red europium activated oxonitridoaluminosilicate phosphor and a red phosphor selected from the group Ca_{1-x-y}SrₓS:Eu_{y}, wherein 0≦x≦1 and 0<y≦0.2; and (Sr_{1-x-y}BaₓCa_{y})₂Si₅N₈:Eu_{z}, wherein 0≦x≦1, 0≦y≦1 and 0<z≦0.2.

An orange to red-light emitting illumination system according to the invention can particularly preferably be realized by admixing an excess of the inorganic luminescent blend of Ba₂Si₅N₈:Eu and Sr₂Si₃Al₂N₆O₂:Eu with a silicone resin used to produce the luminescence conversion encapsulation or layer. Part of a UV radiation emitted by a UV-emitting diode is shifted by the inorganic luminescent material comprising Ba₂Si₅N₈:Eu and Sr₂Si₃Al₂N₆O₂:Eu into the orange to red spectral region. A human observer will perceive the combination of UV-primary radiation and the excess secondary light of the phosphors as orange to red light.

Orange to red emitting LEDs with a color point on the line connecting x=0.516, y=0.482 and x=0.636, y=0.363 can be made by applying a luminescent material which comprises a blend of Ba₂Si₅N₈:Eu and Sr₂Si₃Al₂N₆O₂:Eu.

The luminescent materials may be a blend of two phosphors, a yellow to red europium-activated oxonitridoaluminosilicate phosphor and a yellow to green phosphor selected from the group comprising (CaₓSr_{1-x-y})₂SiO₄:Eu_{y}, wherein 0≦x≦ and 0<y≦0.2, (SrₓBa_{1-x-y})₂SiO₄:Eu_{y}, wherein 0≦x≦1 and 0<y≦0.2, (Sr_{1-x-y}Baₓ)Ga₂S₄:Eu_{y}, wherein 0≦x≦1 and 0<y≦0.2, (Y_{1-x-y-z}GdₓLu_{z})₃(Al₁₋ₐGaₐ)₅O₁₂:Ce_{y}, wherein 0≦x≦1 and 0<y≦0.2, 0≦z≦1, 0≦a≦0.5, ZnS:Cu, CaS:Ce,Cl, and SrSi₂N₂O₂:Eu.

The luminescent materials may be a blend of two phosphors, a yellow to red europium-activated oxonitridoaluminosilicate phosphor and a blue phosphor selected from the group comprising BaMgAl₁ₒ0₁₇:Eu, Ba₅SiO₄(Cl,Br)₆:Eu, CaLa₂S₄:Ce, (Sr,Ba,Ca)₅(PO₄)₃Cl:Eu, and LaSi₃N₅:Ce.

The luminescent materials may be a blend of three phosphors, e.g. a yellow to red europium-activated oxonitridoaluminosilicate phosphor, a red phosphor selected from the group Ca_{1-x-y}SrₓS:Eu_{y}, wherein 0≦x≦1 and 0<y≦0.2; and (Sr_{1-x-y}BaₓCa_{y})₂Si₅N₈:Eu_{z}, wherein 0≦x≦1, 0≦y≦1 and 0<z≦0.2 and a yellow to green phosphor selected from the group comprising (CaₓSr_{1-x-y})₂SiO₄:Eu_{y}, wherein 0≦x≦and 0<y≦0.2, (SrₓBa_{1-x-y})₂SiO₄:Eu_{y}, wherein 0≦x≦1 and 0<y≦0.2, (Sr_{1-x-y}Baₓ)Ga₂S₄:Eu_{y}, wherein 0≦x≦1 and 0<y≦0.2, (Y_{1-x-y-z}GdₓLu_{z})₃(Al₁₋ₐGaₐ)₅O₁₂:Ce_{y}, wherein 0≦x≦1 and 0<y≦0.2, 0≦z≦1, 0≦a≦0.5, ZnS:Cu, CaS:Ce,Cl, and SrSi₂N₂O₂:Eu.

In the example given above, the red light emitting illumination system according to the invention can particularly preferably be realized by admixing the inorganic luminescent material comprising a mixture of three phosphors with a silicone resin used to produce the luminescence conversion encapsulation or layer. A first phosphor (1) is the yellowish-emitting Ba₂Si₅N₈:Eu, the second phosphor (2) is the red-emitting Sr₂Si₅N₈:Eu, and the third (3) is a deep red-emitting phosphor of the oxonitridoaluminosilicate type Sr₂Si₃Al₂N₆O₂:Eu.

Part of a UV radiation emitted by a UV-emitting diode is shifted by the inorganic luminescent material Ba₂Si₅N₈:Eu into the yellow spectral region. Another part of the radiation emitted by a UV-emitting diode is shifted by the inorganic luminescent material Sr₂Si₅N₈:Eu into the red spectral region. Still another part of radiation emitted by a UV-emitting diode is shifted by the inorganic luminescent material Sr₂Si₃Al₂N₆O₂:Eu into the deep red spectral region. A human observer will perceive the combination of UV primary light and the polychromatic secondary light of the phosphor blend as red light.

The hue (color point in the CIE chromaticity diagram) of the red light thus produced can be varied in this case by a suitable choice of the phosphors as regards their mixture and concentrations.

FIG. 1 is a schematic view of a dichromatic white LED lamp comprising a phosphor of the present invention positioned in a pathway of light emitted by an LED structure.

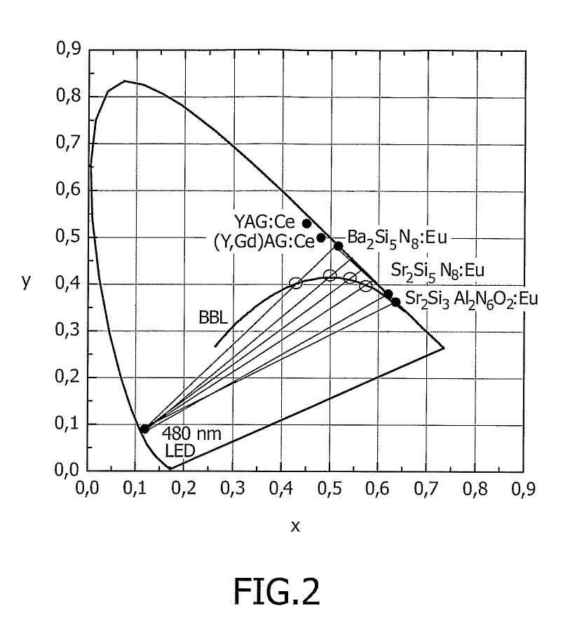

FIG. 2 shows the coordinates of the radiation (color points) in the chromaticity diagram of the Commission Internationale de l'Eclairage (“CIE”) of YAG:Ce, (Y,Gd)AG:Ce, Sr₂Si₅N₈:Eu, Ba₂Si₅N₈:Eu and the boundaries of color points, which can be made with an LED chip emitting at 495 nm and a fluorescent material comprising (Sr_{1-x-y}Baₓ)₂Si₅₋ₐAlₐN₈₋ₐOₐ:Eu_{y}, Sr₂Si₅N₈:Eu, Ba₂Si₅N₈:Eu, or a blend of two or several of these compounds.

1. Illumination system, comprising a radiation source and a fluorescent material comprising at least one phosphor capable of absorbing part of the light emitted by the radiation source and emitting light of a wavelength different from that of the absorbed light; wherein said at least one phosphor is a europium(II)-activated oxonitridoaluminosilicate of the general formula EA_{2-z}Si₅₋ₐAlₐN₈₋ₐOₐ:Eu_{z}, wherein
0<a≦2 and 0<z≦0.2; EA being at least one alkaline earth metal chosen from the group of calcium, barium, and strontium.

2. Illumination system according to claim 1, wherein the radiation source is a solid-state light-emitting diode.

3. Illumination system according to claim 1, for the generation of yellow, amber, or red light, wherein the radiation source is selected from the light-emitting diodes having an emission with a peak emission wavelength in the range of 400 to 495 nm.

4. Illumination system according to claim 3, wherein the fluorescent material comprises a second phosphor.

5. Illumination system according to claim 4, wherein the second phosphor is a red phosphor selected from the group Ca_{1-x-y}SrₓS:Eu_{y}, wherein 0≦x≦1 and 0<y≦0.2; and (Sr_{1-x-y}BaₓCa_{y})₂Si₅N₈:Eu_{z}, wherein 0≦x≦1, 0≦y≦1 and 0<z≦0.2.

6. Illumination system according to claim 4, wherein the second phosphor is a yellow to green phosphor selected from the group comprising (CaₓSr_{1-x-y})₂SiO₄:Eu_{y}, wherein 0≦x≦1 and 0<y≦0.2, (SrₓBa_{1-x-y})₂SiO₄:Eu_{y}, wherein 0≦x≦1 and 0<y≦0.2, (Sr_{1-x-y}Baₓ)Ga₂S₄:Eu_{y}, wherein 0≦x≦1 and 0<y≦0.2, (Y_{1-x-y-z}GdₓLu_{z})₃(Al₁₋ₐGaₐ)₅O₁₂:Ce_{y}, wherein 0≦x≦1 and 0<y≦0.2, 0≦z≦1, 0≦a≦0.5, ZnS:Cu, CaS:Ce,Cl, and SrSi₂N₂O₂:Eu.

7. Illumination system according to claim 4, wherein the second phosphor is a blue phosphor selected from the group of BaMgAl₁ₒ0₁₇:Eu, Ba₅SiO₄(Cl,Br)₆:Eu, CaLa₂S₄:Ce, (Sr,Ba,Ca) ₅(PO₄)₃Cl:Eu, and LaSi₃N₅:Ce.

8. Illumination system according to claim 1, for the generation of yellow, amber, or red light, wherein the radiation source is selected from the light-emitting diodes having an emission with a peak emission wavelength in the UV range of 200 to 420 nm.

9. Illumination system according to claim 8, wherein the fluorescent material comprises a second phosphor.

10. Illumination system according to claim 8, wherein the second phosphor is a red phosphor selected from the group Ca_{1-x-y}SrₓS:Eu_{y}, wherein 0≦x≦1 and 0<y≦0.2; and (Sr_{1-x-y}BaₓCa_{y})₂Si₅N₈:Eu_{z}, wherein 0≦x≦1, 0≦y≦1 and 0<z≦0.2.

11. Illumination system according to claim 8, wherein the second phosphor is a yellow to green phosphor selected from the group comprising (CaₓSr_{1-x-y})₂SiO₄:Eu_{y}, wherein 0≦x≦1 and 0<y≦0.2, (SrₓBa_{1-x-y})₂SiO₄:Eu_{y}, wherein 0≦x≦1 and 0<y≦0.2, (Sr_{1-x-y}Baₓ)Ga₂S₄:Eu_{y}, wherein 0≦x≦1 and 0<y≦0.2, (Y_{1-x-y-z}GdₓLu_{z})₃(Al₁₋ₐGaₐ)₅O₁₂:Ce_{y}, wherein 0≦x≦1 and 0<y≦0.2, 0≦z≦1, 0≦a≦0.5, ZnS:Cu, CaS:Ce,Cl, and SrSi₂N₂O₂:Eu.

12. Illumination system according to claim 8, wherein the second phosphor is a blue phosphor selected from the group of BaMgAl₁₀0₁₇:Eu, Ba₅SiO₄(Cl,Br)₆:Eu, CaLa₂S₄:Ce, (Sr,Ba,Ca) ₅(PO₄)₃Cl:Eu, and LaSi₃N₅:Ce.

13. Phosphor capable of absorbing part of the light emitted by the radiation source and emitting light of a wavelength different from that of the absorbed light; wherein said phosphor is a europium(II)-activated oxonitridoaluminosilicate of the general formula EA_{2-z}Si₅₋ₐAlₐN₈₋ₐOₐ:Eu_{z}, wherein 0<a≦2 and 0<z≦0.2; EA being at least one alkaline earth metal chosen from the group of calcium, barium, and strontium.

14. Phosphor according to claim 13, wherein said phosphor additionally comprises a co-activator selected from the group of ytterbium and samarium.

15. Phosphor according to claim 12, wherein the phosphor has a coating selected from the group of fluorides and orthophosphates of the elements aluminum, scandium, yttrium, lanthanum gadolinium, and lutetium, the oxides of aluminum, yttrium, and lanthanum, and the nitride of aluminum.
